(19) United States
(12) Patent Application Publication
(10) Pub. No.: US 2021/0276033 A1
(43) Pub. Date: Sep. 9, 2021

(54) ATOMIZER

(71) Applicant: Murata Manufacturing Co., Ltd., Kyoto (JP)

(72) Inventors: Miki IKEDA, Kyoto (JP); Kiyoshi KURIHARA, Kyoto (JP); Susumu TAKEUCHI, Kyoto (JP); Kenichiro KAWAMURA, Kyoto (JP); Kenjiro OKAGUCHI, Kyoto (JP); Masaaki FUJISAKI, Kyoto (JP); Yohei Kawasaki, Kyoto (JP); Hiroaki WADA, Kyoto (JP)

(21) Appl. No.: 17/330,473

(22) Filed: May 26, 2021

Related U.S. Application Data
(63) Continuation of application No. PCT/JP2019/046615, filed on Nov. 28, 2019.

(30) Foreign Application Priority Data
Nov. 28, 2018 (JP) 2018-222720
Mar. 20, 2019 (JP) 2019-052660

(51) Int. Cl. B05B 17/06; B05B 7/24

(52) U.S. Cl. CPC B05B 17/0607; B05B 7/2491

(57) ABSTRACT

An atomizer includes a first piezoelectric pump, a first flow path, a reservoir part, and a second flow path. The first piezoelectric pump ejects gas through an outlet. The first flow path has a first end and a second end. The first end of the first flow path is connected to the outlet of the first piezoelectric pump. A connection point is provided between the first and second ends of the first flow path. Liquid is to be stored in the reservoir part. The second flow path has a first end and a second end. The first end of the second flow path is connected to the liquid reservoir part. The second end of the second flow path is connected to the connection point.

### CROSS REFERENCE TO RELATED APPLICATION

This is a continuation of International Application No. PCT/JP2019/046615 filed on Nov. 28, 2019 which claims priority from Japanese Patent Application No. 2018-222720 filed on Nov. 28, 2018 and Japanese Patent Application No. 2019-052660 filed on Mar. 20, 2019. The contents of these applications are incorporated herein by reference in their entireties.

### BACKGROUND

### Technical Field

The present disclosure relates to an atomizer that forms a liquid-gas mixture and reduces the mixture to a fine spray.

Such an atomizer that forms a liquid-gas mixture and reduces the mixture to a fine spray is disclosed in, for example, Patent Document 1.

The atomizer disclosed in Patent Document 1 includes a spray tank and a reservoir. A jet of air in the gaseous form is ejected from the spray tank, and liquid is stored in the reservoir. The spray tank is connected to the reservoir in a manner so as to be user-operable for ejection of a jet of air. A junction of the spray tank and the reservoir has a constricted section where the cross-sectional area of a flow path is reduced. When a jet of air ejected from the spray tank passes through the constricted section, a negative pressure is generated. This is known as Venturi effect. The Venturi effect causes the liquid in the reservoir to be drawn in and to mix with the air for atomization. The atomized liquid is jetted out through an outlet of the atomizer.

Patent Document 1: Japanese Unexamined Patent Application Publication No. 2008-247405

### BRIEF SUMMARY

The constricted section of the atomizer disclosed in Patent Document 1 is a place where a liquid-gas mixture is formed. The liquid-gas ratio for atomizing liquid needs to be optimized in the constricted section, where the velocity of flow of gas also needs to be optimized for the purpose of producing the Venturi effect. A potential downside to the approach of optimizing both the liquid-gas ratio and the velocity of flow of gas may be that the degree of design flexibility concerning the internal shape and the cross-sectional area of the constricted section will be extremely low. That is, in optimizing the liquid-gas ratio for atomizing liquid and in optimizing the velocity of flow of gas for the purpose of producing the Venturi effect, the degree of difficulty in designing the atomizer disclosed in Patent Document 1 can be extremely high.

The present disclosure provides an atomizer that reduces the degree of design difficulty associated with optimizing the liquid-gas ratio for atomizing liquid and with optimizing the velocity of flow of gas for the purpose of producing the Venturi effect.

An atomizer according to the present disclosure includes a first piezoelectric pump, a first flow path, a reservoir part, and a second flow path. The first piezoelectric pump ejects gas through an outlet. The first flow path has a first end and a second end. The first end of the first flow path is connected to the outlet of the first piezoelectric pump. A connection point is provided between the first and second ends of the first flow path. Liquid is to be stored in the reservoir part. The second flow path has a first end and a second end. The first end of the second flow path is connected to the reservoir part. The second end of the second flow path is connected to the connection point.

The atomizer according to the present disclosure reduces the degree of design difficulty associated with optimizing the liquid-gas ratio for atomizing liquid and with optimizing the velocity of flow of gas for the purpose of producing the Venturi effect, and atomization is thus more easily controllable.

### BRIEF DESCRIPTION OF THE SEVERAL VIEWS OF THE DRAWINGS

FIG. 1 is a perspective view of an atomizer according to Embodiment 1.

FIG. 2 is a perspective view of the atomizer according to Embodiment 1, illustrating the internal structure of the atomizer.

FIG. 3 is an enlarged view of a connection point in Embodiment 1.

FIG. 4 illustrates the internal structure of a tank in Embodiment 1.

FIG. 5 is an enlarged view of a region including a flow-path resistive member in Embodiment 1.

FIG. 6 schematically illustrates an atomizer according to Modification 1 of Embodiment 1.

FIG. 7 schematically illustrates an atomizer according to Modification 2 of Embodiment 1.

FIG. 8 illustrates a modification of the flow-path resistive member in Embodiment 1.

FIG. 9 illustrates another modification of the flow-path resistive member in Embodiment 1.

FIG. 10 is a perspective view of an atomizer according to Embodiment 2, illustrating the internal structure of the atomizer.

FIG. 11 is an enlarged view of a connection point in Embodiment 2.

FIG. 12 is a graph illustrating results obtained in relation to pulsations generated in an atomizer including a piezoelectric pump (Example) and pulsations generated in an atomizer including a motor pump (Comparative Example).

FIG. 13 is a graph illustrating the relationship between the gas flow rate and the atomization rate.

FIG. 14 is a graph illustrating the atomization rate of the atomizer in Comparative Example.

FIG. 15 is a graph illustrating the atomization rate of the atomizer in Example.

FIG. 16 is a graph for comparison of the total amount of flow atomized by the atomizer in Comparative Example and the total amount of flow atomized by the atomizer in Example.

FIG. 17 is a graph illustrating the relationship between the flow rate and the particle diameter.

FIG. 18 is a graph illustrating, in relation to varying particle diameters, the constituent percentage of particles of liquid atomized by the atomizer in Comparative Example and the constituent percentage of particles of liquid atomized by the atomizer in Example.

### DETAILED DESCRIPTION

According to a first aspect of the present disclosure, an atomizer includes a first piezoelectric pump, a first flow path, a reservoir part, and a second flow path. The first piezoelectric pump ejects gas through an outlet. The first flow path has a first end and a second end. The first end of the first flow path is connected to the outlet of the first piezoelectric pump. A connection point is provided between the first and second ends of the first flow path. Liquid is to be stored in the reservoir part. The second flow path has a first end and a second end. The first end of the second flow path is connected to the reservoir part. The second end of the second flow path is connected to the connection point.

In operating the piezoelectric pump for ejecting gas, output conditions, such as driving frequencies may be preset such that the settings including the flow rate of the gas are adjusted accordingly. Thus, the degree of design difficulty associated with optimizing the liquid-gas ratio for atomizing liquid and with optimizing the velocity of flow of gas for the purpose of producing the Venturi effect is lower for the atomizer including the piezoelectric pump than for atomizers including other types of pumps, and atomization is thus more easily controllable.

According to a second aspect of the present disclosure, the atomizer according to the first aspect may further include a branch flow path having a first end and a second end. The first end of the branch flow path is connected between the first end of the first flow path and the connection point. The second end of the branch flow path is connected to the reservoir part. This feature enables the first piezoelectric pump to serve as a driving source for transferring both gas and liquid. Thus, the atomizer may be less costly to produce and may be more compact in size.

According to a third aspect of the present disclosure, the branch flow path in the atomizer according to the second aspect may be provided with a backflow prevention mechanism that eliminates or reduces occurrence of backflow of liquid. This feature eliminates or reduces occurrence of accidental backflow of liquid from the reservoir part through the branch flow path and thus helps increase the reliability of the atomizer.

According to a fourth aspect of the present disclosure, the atomizer according to the first aspect may further include a second piezoelectric pump and a third flow path. The second piezoelectric pump ejects gas through an outlet. The third flow path has a first end and a second end. The first end of the third flow path is connected to the outlet of the second piezoelectric pump. The second end of the third flow path is connected to the reservoir part. This feature enables the piezoelectric pump to serve as a driving source for transferring not only gas but also liquid. It is therefore easy to adjust the settings including the flow rate of the liquid fed to the connection point, and atomization is thus more easily controllable.

According to a fifth aspect of the present disclosure, the atomizer according to the fourth aspect may further include a bypass flow path through which a spot on the first flow path between the first end of the first flow path and the connection point is connected to the third flow path. This feature, or more specifically, the bypass flow path enables the exchange of gas between the first flow path and the third flow path such that the flow rates in the first and third flow paths are dependently adjustable.

According to a sixth aspect of the present disclosure, the third flow path in the atomizer according to the fifth aspect may be provided with a flow-path resistive member that is closer than a junction of the third flow path and the bypass flow path to the second end of the third flow path. This feature, or more specifically, the flow-path resistive member provided to the third flow path enhances the flow of gas from the third flow path into the bypass flow path and further into the first flow path, and the flow rate of the gas passing through the first flow path is increased accordingly. In this way, the atomization taking place at the connection point is accelerated.

According to a seventh aspect of the present disclosure, the third flow path in the atomizer according to any one of the fourth to sixth aspects may be provided with a backflow prevention mechanism that eliminates or reduces occurrence of backflow of liquid. This feature eliminates or reduces occurrence of accidental backflow of liquid from the reservoir part through the third flow path to the second piezoelectric pump and thus helps increase the reliability of the atomizer.

According to an eighth aspect of the present disclosure, the first flow path in the atomizer according to any one of the first to seventh aspects may extend in a straight line from the first end to the second end. This feature is conducive to maintaining, as far as possible, the velocity of the gas ejected from the first piezoelectric pump such that the atomization takes place with a higher degree of reliability.

According to a ninth aspect of the present disclosure, the atomizer according to any one of the first to eighth aspects may further include a case in which at least the first piezoelectric pump, the first flow path, the second flow path, and the reservoir part are housed. This feature provides the user with added convenience of portability.

According to a tenth aspect, the reservoir part of the atomizer according to the ninth aspect may be a tank housed in the case. This feature ensures that a predetermined storage capacity for liquid is provided.

According to an eleventh aspect, the second flow path in the atomizer according to any one of the first to tenth aspects may be connected to the first flow path in a manner so as to cross the first flow path, with a tip portion of the second flow path being bent in the first flow path and extending toward the exit point of the first flow path in such a manner that the first flow path and the tip portion of the second flow path in the first flow path are concentric. This feature renders such a simple nozzle structure usable for atomization.

### Embodiment 1

Embodiment 1 of the present disclosure will be described below in detail with reference to the drawings.

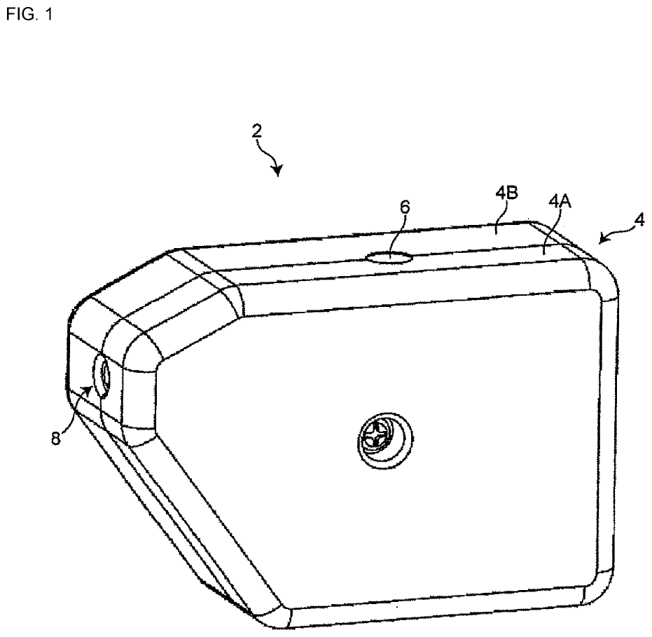

FIG. 1 is an external perspective view of an atomizer 2 according to Embodiment 1 of the present disclosure.

The atomizer 2 forms a liquid-gas mixture and reduces the mixture to a fine spray. Referring to FIG. 1, the atomizer 2 includes a case 4, a switch 6, and an outlet 8. The atomizer 2 may be used as a medical nebulizer. The liquid to be used may be a physiological saline solution, an organic solvent (e.g., ethanol), a medicine (e.g., steroids and β2-agonists). The gas to be used may be air. When the switch 6 is depressed by the user, the liquid is atomized and jetted out through the outlet 8.

The case 4 is a member that forms the contour of the atomizer 2. The switch 6 is exposed at an upper surface of the case 4. The switch 6 is a switching member that causes the atomizer 2 to perform electrical on-off switching.

The outlet 8 is provided in a side of the case 4. The outlet 8 is an opening through which the atomized liquid is jetted out.

The case 4 includes a first case portion 4A and a second case portion 4B. Referring to FIG. 1, the first case portion 4A and the second case portion 4B are fastened to each other with a screw.

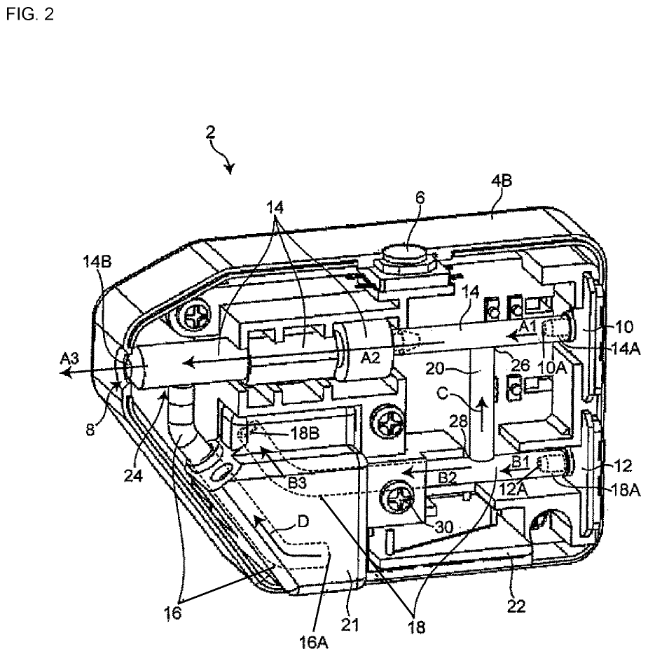

FIG. 2 illustrates the atomizer 2 with the first case portion 4A removed. As illustrated in FIG. 2, the atomizer 2 includes a first piezoelectric pump 10, a second piezoelectric pump 12, a first flow path 14, a second flow path 16, a third flow path 18, a bypass flow path 20, a tank 21, and a control board 22. These members are housed in the case 4.

The first piezoelectric pump 10 and the second piezoelectric pump 12 are piezoelectric pumps including piezoelectric elements and may also be referred to as microblowers or micropumps. More specifically, the first piezoelectric pump 10 and the second piezoelectric pump 12 each have a structure including a metal plate (not illustrated) and a piezoelectric element (not illustrated) pasted on the metal plate. When being supplied with alternating-current power, the structure including a piezoelectric element and a metal plate flexes and deforms in a unimorph mode to transfer gas. Such a piezoelectric pump includes a diaphragm (not illustrated) that functions as a valve for causing gas to flow in only one direction.

The first piezoelectric pump 10 has an outlet 10A, through which gas is ejected in the direction of an arrow A1. Likewise, the second piezoelectric pump 12 has an outlet 12A, through which gas is ejected in the direction of an arrow B1. In Embodiment 1, the direction of the arrow A1 is parallel to the direction of the arrow B1, and both the direction of the arrow A1 and the direction of the arrow B1 are in the horizontal direction.

The first piezoelectric pump 10 is connected with the first flow path 14, through which the gas ejected from the first piezoelectric pump 10 flows. The first flow path 14 has an entry point and an exit point, which are herein referred to as a first end 14A and a second end 14B, respectively. The first end 14A is connected to the outlet 10A of the first piezoelectric pump 10, and the second end 14B faces the outlet 8. The first flow path 14 in Embodiment 1 extends in a straight line from the first end 14A to the second end 14B. The direction in which the first flow path 14 extends is denoted by an arrow A2, and the direction in which the gas is jetted out through the outlet 8 is denoted by an arrow A3. Both the direction of the arrow A2 and the direction of the arrow A3 coincide with the direction of the arrow A1 such that the gas ejected through the outlet 10A of the first piezoelectric pump 10 flows linearly to the second end 14B and is jetted out through the outlet 8.

The first flow path 14 and the second flow path 16 are connected to each other at a site close to the second end 14B. The second flow path 16 is a pathway through which liquid stored in the tank 21 is transferred to the first flow path 14. The second flow path 16 has an entry point and an exit point, which are herein referred to as a first end 16A and a second end 16B (see FIG. 3), respectively. The first end 16A is connected to the tank 21, and the second end 16B is connected to the first flow path 14. The site at which the second flow path 16 is connected to the first flow path 14 is herein referred to as a connection point 24. The connection point 24 is a mixing point at which the gas mixes with the liquid.

FIG. 3 is an enlarged view of the connection point 24. As illustrated in FIG. 3, the second flow path 16 is connected to the first flow path 14 in such a manner that the first flow path 14 and the second flow path 16 cross each other at about right angles. The second flow path 16 has a tip portion 25, which is bent at about a 90° angle in such a manner that the first flow path 14 and the tip portion 25 in the first flow path 14 are concentric. The second end 16B of the second flow path 16 faces the second end 14B of the first flow path 14. With this nozzle-shaped section (i.e., injector) being provided, the liquid transferred through the second flow path 16 flows through a core portion of the first flow path 14 as indicated by arrows D1, and the gas ejected from the first piezoelectric pump 10 flows through a peripheral portion around the core portion as indicated by arrows A2. The velocity and flow rate of the gas ejected from the first piezoelectric pump 10 may thus be adjusted to fall within a desired range in accordance with, for example, the flow rate of the liquid transferred through the second flow path 16 such that the liquid is atomized at the connection point 24.

Referring back to FIG. 2, the second piezoelectric pump 12 is connected with the third flow path 18, through which the gas ejected from the second piezoelectric pump 12 flows to the tank 21. The third flow path 18 has an entry point and an exit point, which are herein referred to as a first end 18A and a second end 18B, respectively. The first end 18A is connected to the outlet 12A of the second piezoelectric pump 12, and the second end 18B is located within the tank 21 in a manner so as not to be in contact with the liquid stored in the tank 21. The third flow path 18 extends from the outlet 12A of the second piezoelectric pump 12 and is connected to the inner space of the tank 21. The third flow path 18 extends in the direction of an arrow B2, which coincides with the direction of the arrow B1, and is curved to extend in a slanting upward direction indicated by an arrow B3.

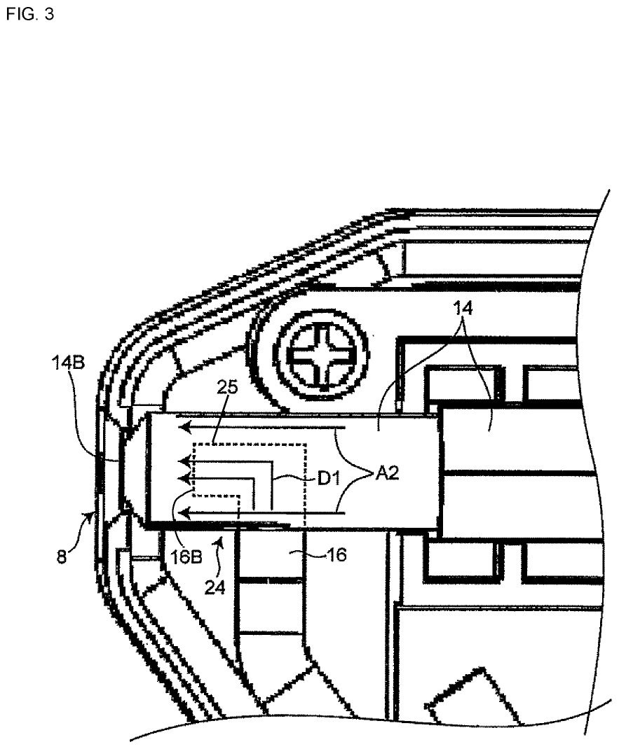

The tank 21 is a reservoir part in which liquid is stored. The following describes the internal structure of the tank 21 with reference to FIG. 4. FIG. 4 illustrates a region including the tank 21.

Referring to FIG. 4, the liquid level in the tank 21 is denoted by H. The first end 16A of the second flow path 16 is located below the liquid level H, and the second end 18B of the third flow path 18 is located above the liquid level H.

The gas transferred through the third flow path 18 is ejected through the second end 18B into the tank 21 accordingly. The resultant increase in the pressure in the tank 21 translates into a force that causes a fall in the liquid level H. This force causes the liquid in the tank 21 to move in the direction from the first end 16A of the second flow path 16 toward the connection point 24 such that the liquid flows upward through the second flow path 16 as indicated by an arrow D.

That is, the second end 18B of the third flow path 18 is positioned in such a manner that the gas ejected from the third flow path 18 causes the liquid in the tank 21 to flow toward the first end 16A of the second flow path 16.

Referring back to FIG. 2, the bypass flow path 20 extends between the first flow path 14 and the third flow path 18. The bypass flow path 20 enables the exchange of gas between the first flow path 14 and the third flow path 18. The bypass flow path 20 and the first flow path 14 are connected to each other at a connection point 26, and the bypass flow path 20 and the third flow path 18 are connected to each other at a connection point 28. The connection points 26 and 28 are located upstream of the connection point 24. The connection point 26 is located between the first end 14A of the first flow path 14 and the connection point 24.

The bypass flow path 20 in Embodiment 1 serves as a pathway through which the gas flowing through the third flow path 18 is led to the first flow path 14 as indicated by an arrow C. More specifically, the bypass flow path 20 has an entry point (a first end) and an exit point (a second end), which coincide with the connection points 28 and 26, respectively. The third flow path 18 is provided with a flow-path resistive member 30, which aids in producing the flow of gas.

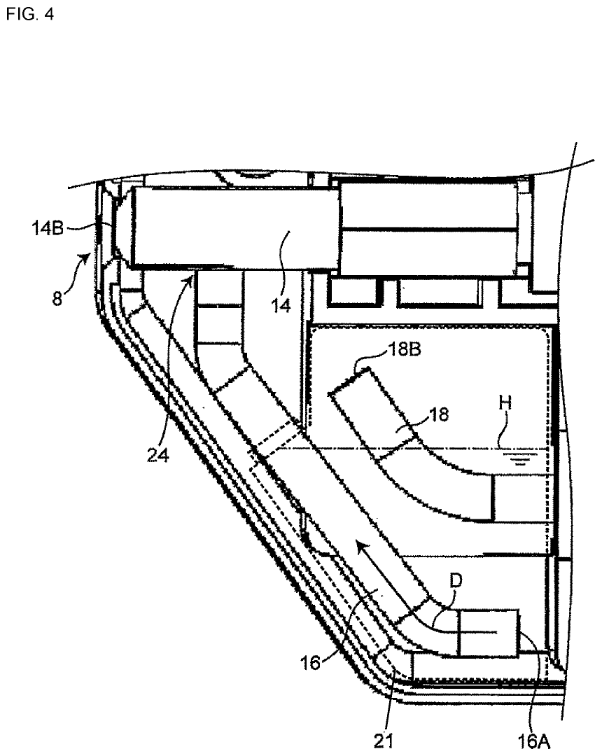

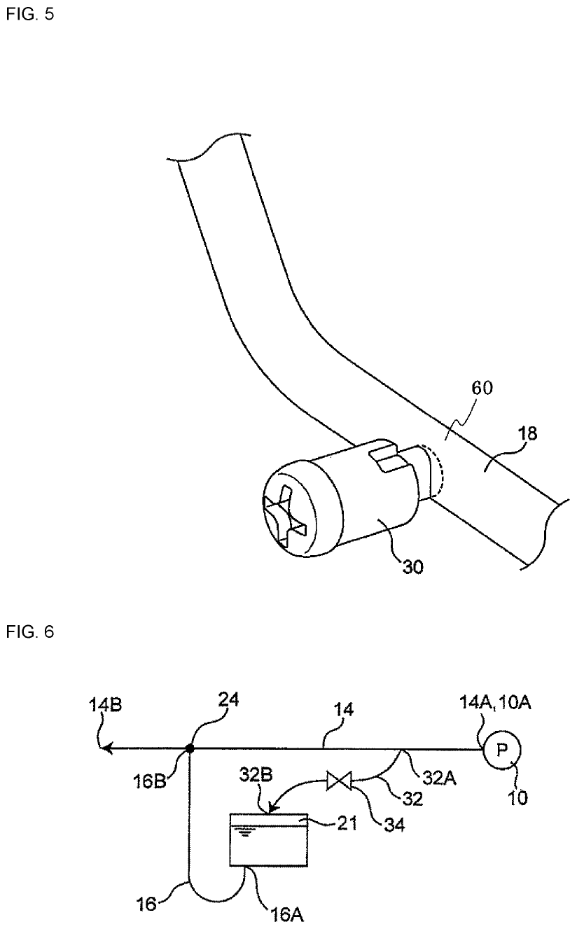

FIG. 5 is an enlarged view of a region including the flow-path resistive member 30. As illustrated in FIG. 5, the flow-path resistive member 30 in Embodiment 1 is partially embedded in the third flow path 18 to act as a valve. More specifically, the flow-path resistive member 30 protrudes into the third flow path 18 to form a constricted section 60, where a local reduction in the cross-sectional area of the third flow path 18 enables the constricted section 60 to provide flow-path resistance. Instead of being embedded in the third flow path 18, the flow-path resistive member 30 may exert external stress on the third flow path 18, which is in turn deformed to provide the constricted section 60. The constricted section 60 provides added resistance to the third flow path 18 such that the flow of gas into the bypass flow path 20 and the first flow path 14 is enhanced accordingly. It is not required that the flow-path resistive member 30 be in the form of a valve. The flow-path resistive member 30 may be in the form of an orifice plate or in any other form that provides flow-path resistance. The third flow path 18 may become constricted through deformation caused by a simple cylindrical body that is not a valve. Such a cylindrical body may also be used as a flow-path resistive member.

The flow-path resistive member 30 is disposed downstream of the connection point 28, which is illustrated in FIG. 2. This layout enhances the flow of gas from the third flow path 18 into the bypass flow path 20 and further into the first flow path 14, and the flow rate of the gas passing through the first flow path 14 is increased accordingly. In this way, the atomization taking place at the connection point 24 is accelerated.

The undiverted stream of gas flows through the third flow path 18 into the tank 21.

The control board 22 is a member for driving a piezoelectric pump. The control board 22 in Embodiment 1 drives the second piezoelectric pump 12. The first piezoelectric pump 10 is provided with a dedicated control board (not illustrated).

The control board 22 is electrically connected to the switch 6 and to the second piezoelectric pump 12. When the switch 6 is depressed by the user, a signal is sent from the switch 6 to the control board 22. Upon receipt of the signal, the control board 22 applies driving voltage to the second piezoelectric pump 12, which in turn goes into action. Likewise, the dedicated control board (not illustrated) applies driving voltage to the first piezoelectric pump 10, which in turn goes into action. That is, depression of the switch 6 causes the first piezoelectric pump 10 and the second piezoelectric pump 12 to go into action at the same time. The driving voltage applied to the piezoelectric pump 10 and 12 may be in the range of 20 to 40 kHz. The first piezoelectric pump 10 and the second piezoelectric pump 12 in Embodiment 1 are of the same specification and have the same output level.

As illustrated in FIG. 1, some of the aforementioned constituent components, such as the switch 6 are not covered with the case 4. The other constituent components of the atomizer 2 in Embodiment 1 are all housed in the case 4.

The following describes the operation of the atomizer 2 configured as above. The operation is initiated when the switch 6 is depressed by the user. Depression of the switch 6 causes the first piezoelectric pump 10 and the second piezoelectric pump 12 to go into action. The first piezoelectric pump 10 and the second piezoelectric pump 12 simultaneously eject gas in the directions of the arrows A1 and B1, respectively. The first piezoelectric pump 10 and the second piezoelectric pump 12 in Embodiment 1 have the same output level. Thus, the gas ejected from the first piezoelectric pump 10 and the gas ejected from the second piezoelectric pump 12, respectively, pass through the outlet 10A and the outlet 12A at the same flow rate and at the same velocity.

As already described above, the flow-path resistive member 30 provided to the third flow path 18 diverts some of the gas from the third flow path 18 into the bypass flow path 20 and further into the first flow path 14 as indicated by the arrow C. The diversion results in an increase in the flow rate of gas in the first flow path 14 and a decrease in the flow rate of gas in the third flow path 18.

As indicated by the arrow A2, the gas transferred through the first flow path 14 is fed to the connection point 24. More specifically, the gas ejected from the first piezoelectric pump 10 flows linearly through the first flow path 14 and then reaches the connection point 24. The linear propagation has an advantage in that the reduction in the velocity of the gas ejected from the first piezoelectric pump 10 may be minimized, and the velocity of the gas may be maintained accordingly.

As indicated by the arrows B2 and B3, the gas transferred through the third flow path 18 flows into the tank 21. The gas flowing into the tank 21 exerts a force that causes a fall in the liquid level in the tank 21. Consequently, the liquid in the tank 21 flows to the first end 16A of the second flow path 16 and is fed to the connection point 24 as indicated by the arrow D.

The gas mixes with the liquid at the connection point 24. Referring to FIG. 3, the liquid flows through the tip portion 25 of the second flow path 16 to the second end 14B of the first flow path 14 as indicated by the arrows D1, and the gas flows through the peripheral portion as indicated by the arrows A2. The flow rates and velocities of the gas and the liquid fed to the connection point 24 are preset to predetermined values at which conditions needed for atomization are satisfied. It is thus ensured that the atomization takes place at the connection point 24. The atomized liquid reaches the second end 14B of the first flow path 14 and is then jetted out through the outlet 8.

As described above, the piezoelectric pumps 10 and 12 in the atomizer 2 according to Embodiment 1 serve as a driving source for atomization. In operating the piezoelectric pumps 10 and 12, output conditions, such as driving frequencies may be preset such that the flow rate and velocity of the gas fed to the connection point 24 are adjusted accordingly. The flow rate and velocity of the gas fed to the connection point 24 may thus be brought into appropriate ranges in accordance with, for example, the flow rate of the liquid. This enables the liquid to be atomized with high accuracy. The degree of design difficulty associated with optimizing the liquid-gas ratio for atomizing liquid and with optimizing the velocity of flow of gas for the purpose of producing the Venturi effect is lower for the atomizer 2 than for conventional atomizers that use compressor pumps to atomize liquid with the aid of the Venturi effect. The atomizer 2 according to Embodiment 1 facilitates atomization and provides ease of controlling atomization. The flow rate and velocity of gas may be varied within the allowable range for atomization such that liquid is reduced to particles with a desired diameter. In ejecting gas, the piezoelectric pumps 10 and 12 cause their respective piezoelectric elements to oscillate at high speed. The use of piezoelectric pumps thus reduces occurrence of pulsations. This translates into excellent low noise performance. The piezoelectric pumps 10 and 12 driven in regular cycles enable the atomizer 2 to continuously jet out a fixed volume of atomized liquid. The piezoelectric pumps 10 and 12 may each be smaller than a typical compressor pump, and the atomizer 2 may thus be more compact in size.

As already described above, the atomizer 2 according to Embodiment 1 includes the first piezoelectric pump 10, the first flow path 14, the tank 21, and the second flow path 16. The first piezoelectric pump 10 ejects gas through the outlet 10A. The first flow path 14 has the first end 14A and the second end 14B. The first end 14A is connected to the outlet 10A of the first piezoelectric pump 10. The connection point 24 is provided between the first end 14A and the second end 14B. The tank 21 is a reservoir part in which liquid is stored. The second flow path 16 has the first end 16A and the second end 16B. The first end 16A is connected to the tank 21, and the second end 16B is connected to the connection point 24.

In operating the first piezoelectric pump 10 serving as a driving source for ejecting gas, output conditions, such as driving frequencies may be preset such that the settings including the flow rate of the gas are adjusted accordingly. Thus, the degree of design difficulty associated with optimizing the liquid-gas ratio for atomizing liquid and with optimizing the velocity of flow of gas for the purpose of producing the Venturi effect is lower for the atomizer including the piezoelectric pump than for atomizers including other types of pumps, and atomization is thus more easily controllable.

The atomizer 2 according to Embodiment 1 also includes the second piezoelectric pump 12 and the third flow path 18. The second piezoelectric pump 12 ejects gas through the outlet 12A. The third flow path 18 has the first end 18A and the second end 18B. The first end 18A is connected to the outlet 12A of the second piezoelectric pump 12, and the second end 18B is connected to the tank 21. This feature enables the piezoelectric pump to serve as a driving source for transferring not only gas but also liquid. It is therefore easy to adjust the settings including the flow rate of the liquid fed to the connection point 24, and atomization is thus more easily controllable.

The atomizer 2 according to Embodiment 1 also includes the bypass flow path 20, through which a spot on the first flow path 14 between the first end 14A and the connection point 24 is connected to the third flow path 18. The bypass flow path 20 enables the exchange of gas between the first flow path 14 and the third flow path 18 such that the flow rates in the flow paths 14 and 18 are dependently adjustable.

The atomizer 2 according to Embodiment 1 also includes the flow-path resistive member 30, which is provided to the third flow path 18. The flow-path resistive member 30 is closer than the connection point 28, which is a junction of the third flow path 18 and the bypass flow path 20, to the second end 18B; that is, the flow-path resistive member 30 is located downstream of the connection point 28. The flow-path resistive member 30 enhances the flow of gas passing through the bypass flow path 20 in the direction from the third flow path 18 to the first flow path 14, and the flow rate of the gas in the first flow path 14 is increased accordingly. In this way, the atomization taking place at the connection point 24 is accelerated.

The first flow path 14 of the atomizer 2 according to Embodiment 1 extends in a straight line from the first end 14A to the second end 14B. The gas ejected from the first piezoelectric pump 10 flows linearly through the first flow path 14 and is jetted out of the second end 14B. The velocity of the gas ejected from the first piezoelectric pump 10 may thus be maintained as far as possible, and the atomization taking place at the connection point 24 is accelerated accordingly.

The atomizer 2 according to Embodiment 1 also includes the case 4. The case 4 may, for example, provide the user with added convenience of portability.

The atomizer 2 according to Embodiment 1 includes the tank 21, which is housed in the case 4. The tank 21 is the reservoir part in which liquid is stored. The tank 21 ensures that a predetermined storage capacity for liquid is provided.

The second flow path 16 of the atomizer 2 according to Embodiment 1 is connected to the first flow path 14 in a manner so as to cross the first flow path 14. The tip portion 25 of the second flow path 16 is bent in the first flow path 14 and extends toward the second end 14B of the first flow path 14 in such a manner that the first flow path 14 and the tip portion 25 in the first flow path 14 are concentric. This feature renders such a simple nozzle structure usable for atomization.

Embodiment 1, which has been described so far as an example of the present disclosure, should not be construed as limiting the present disclosure. For example, the bypass flow path 20 in Embodiment 1 is optional. More specifically, the first flow path 14 provided for the first piezoelectric pump 10 and the third flow path 18 provided for the second piezoelectric pump 12 may be independent of each other. The flow rate and velocity of the gas fed to the connection point 24 is controlled in accordance with the output of the first piezoelectric pump 10, and the flow rate and velocity of the liquid fed to the connection point 24 is controlled in accordance with the output of the second piezoelectric pump 12. That is, the control of the flow rate and velocity of gas and the control of the flow rate and velocity of liquid are exercised independently of each other, which provides ease of controlling atomization.

Either of two piezoelectric pumps (i.e., the piezoelectric pump 10 or the piezoelectric pump 12) in Embodiment 1 is optional. For example, the atomizer 2 according to Embodiment 1 may include only the first piezoelectric pump 10; that is, the second piezoelectric pump 12 may be omitted. The liquid in the tank 21 may be transferred to the connection point 24 through a branch flow path that branches off from the first flow path 14 to the tank 21. The configuration modified by the addition of a branch flow path is illustrated in FIG. 6.

FIG. 6 schematically illustrates the modification in which only one piezoelectric pump (the piezoelectric pump 10) is included, with the branch flow path being denoted by 32. As illustrated in FIG. 6, a spot on the first flow path 14 between the first end 14A and the connection point 24 (i.e., a point located upstream of the connection point 24) is connected to the tank 21 through the branch flow path 32. The branch flow path 32 has an entry point and an exit point, which are herein referred to as a first end 32A and a second end 32B, respectively. The first end 32A and the first flow path 14 are connected to each other at a point located upstream of the connection point 24, and the second end 32B is connected to the tank 21. The second end 32B of the branch flow path 32 is positioned in such a manner that the gas ejected from the branch flow path 32 causes the liquid in the tank 21 to flow toward the first end 16A of the second flow path 16. The branch flow path 32 enables the first piezoelectric pump 10 to serve as a driving source for transferring both gas and liquid. Thus, the atomizer 2 may be less costly to produce and may be more compact in size.

The branch flow path 32 in the modification illustrated in FIG. 6 is provided with a backflow prevention mechanism 34, which eliminates or reduces occurrence of backflow of liquid. The backflow prevention mechanism 34 provided to the branch flow path 32 eliminates or reduces occurrence of accidental backflow of liquid from the tank 21 through the branch flow path 32 and thus helps increase the reliability of the atomizer 2. The backflow prevention mechanism 34 may be a filter or any other mechanism that is impervious to liquid and allows gas to pass therethrough.

Likewise, the third flow path 18 (see, for example, FIG. 2) may be provided with a backflow prevention mechanism (not illustrated). The backflow prevention mechanism provided to the third flow path 18 eliminates or reduces occurrence of accidental backflow of liquid from the tank 21 to the second piezoelectric pump 12 through the third flow path 18. The backflow prevention mechanism thus helps increase the reliability of the atomizer 2. The backflow prevention mechanism may, for example, be provided to the first end 18A of the third flow path 18, in which case correct functioning is ensured irrespective of the up-and-down relationship between the second end 18B of the third flow path 18 and the liquid level H. This modification provides greater design flexibility than Embodiment 1, which requires the second end 18B to be always located above the liquid level H.

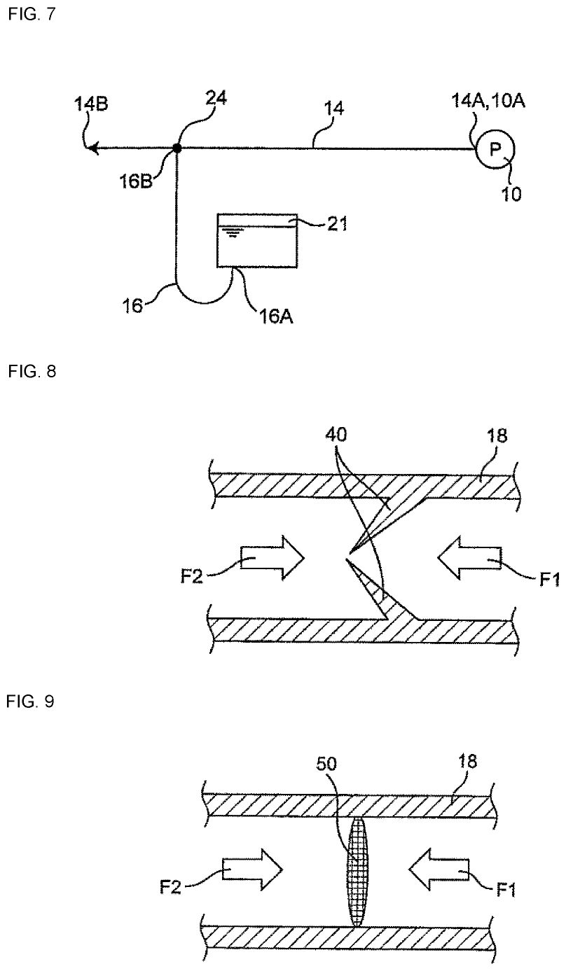

The modification illustrated in FIG. 6 may be further modified in such a way as to omit the branch flow path 32 and the backflow prevention mechanism 34. FIG. 7 illustrates such a modification, in which the omission of the branch flow path 32 renders the first piezoelectric pump 10 incapable of causing liquid to flow out of the tank 21. That is, the liquid in the tank 21 is fed to the connection point 24 by a means other than piezoelectric pumps. As an alternative to the piezoelectric pump, the Venturi effect may be exerted so as to draw in liquid, or the first end 16A of the second flow path 16 may be located above the second end 16B such that liquid is transferred by gravity. In either case, a mixture of the gas ejected from the first piezoelectric pump 10 and the liquid transferred from the tank 21 is formed and atomized at the connection point 24.

In Embodiment 1, the tank 21 is used as the reservoir part in which liquid is stored. Alternatively, the reservoir part may be a flow path in the case 4 or may be in any other form.

It is not required that added resistance to the third flow path 18 be provided by the flow-path resistive member 30 in Embodiment 1. As another approach to providing added resistance to the third flow path 18, the cross-sectional area of the third flow path 18 may be made smaller than the cross-sectional area of the first flow path 14 and smaller than the cross-sectional area of the bypass flow path 20. The resultant increase in the resistance in the third flow path 18 is conducive to enhancing the flow of gas into the bypass flow path 20 and the first flow path 14. Alternatively, the third flow path 18 may be provided with a backflow prevention valve 40, which is illustrated in FIG. 8. The backflow prevention valve 40 increases the resistance to a flow F1, which passes through the third flow path 18 toward the second end 18B. The flow of gas into the bypass flow path 20 and the first flow path 14 is enhanced accordingly. The backflow prevention valve 40 eliminates or reduces the possibility that a flow F2, which is opposite in direction to the flow F1, will take place. The occurrence of backflow of fluid from the tank 21 to the third flow path 18 is eliminated or reduced accordingly. Still alternatively, the third flow path 18 may be provided with a mesh member 50, which is illustrated in FIG. 9. The mesh member 50 is a net-like member with spaces in it and allows gas to pass therethrough while being impervious to liquid. The mesh member 50 increases the resistance to the flow F1 in the third flow path 18 and eliminates or reduces the possibility that the backflow from the tank 21, namely, the flow F2 will take place.

These modifications are also applicable to Embodiment 2, which will be described below.

### Embodiment 2

The following describes an atomizer 102 according to Embodiment 2 of the present disclosure. Features common to Embodiment 1 and Embodiment 2 will be omitted from the following description, which will be given while focusing on differences between Embodiment 1 and Embodiment 2. Each component described in Embodiment 1 and the corresponding component in Embodiment 2 are denoted by the same reference sign, and description thereof will be omitted where appropriate.

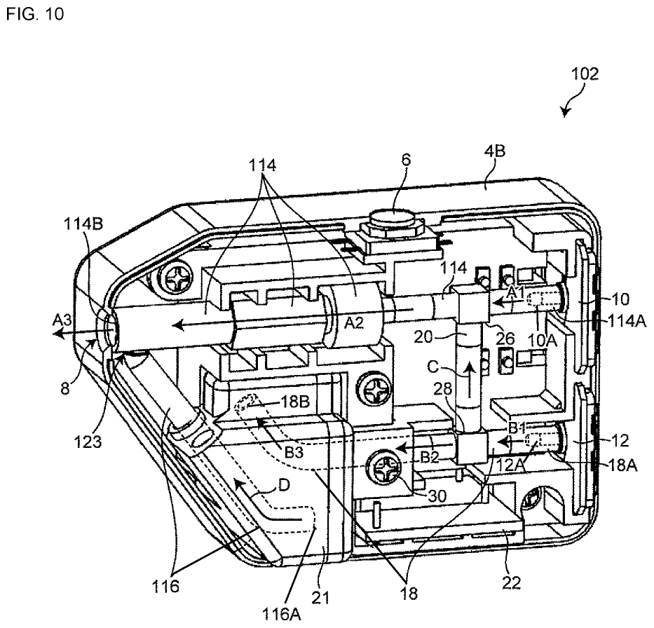

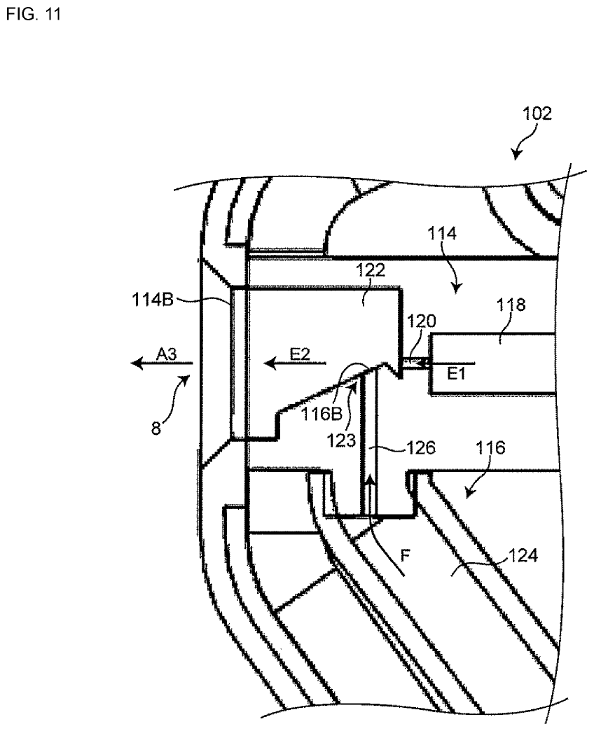

FIG. 10 is a perspective view of the atomizer 102 according to Embodiment 2, illustrating the internal structure of the atomizer 102. FIG. 11 is an enlarged view of a connection point of the atomizer 102 according to Embodiment 2. The difference between the atomizer 102 according to Embodiment 2 and the atomizer 2 according to Embodiment 1 is mainly in the shapes of the first and second flow paths, or more specifically, the shapes of portions including the second ends of the respective flow paths.

Referring to FIG. 10, a first flow path 114 has a first end 114A and a second end 114B. The first end 114A is connected to the outlet 10A of the first piezoelectric pump 10, and the second end 114B faces the outlet 8.

As illustrated in FIG. 11, the first flow path 114 includes a first larger-diameter flow path 118, a smaller-diameter flow path 120, and a second larger-diameter flow path 122, which are arranged in the stated order from the upstream side. The inside diameter of the smaller-diameter flow path 120 is smaller than the inside diameter of the first larger-diameter flow path 118 and smaller than the inside diameter of the second larger-diameter flow path 122. The smaller-diameter flow path 120 is connected between the first larger-diameter flow path 118 and the second larger-diameter flow path 122. The extremity of the second larger-diameter flow path 122 coincides with the second end 114B of the first flow path 114.

A second flow path 116 has a first end 116A (see FIG. 10) and a second end 116B (see FIG. 11). The first end 116A is connected to the inner space of the tank 21, and the second end 116B is connected to a point between two ends of the first flow path 114. The second end 116B of the second flow path 116 coincides with a connection point 123, at which the second flow path 116 is connected to the first flow path 114.

The second flow path 116 includes a larger-diameter flow path 124 and a smaller-diameter flow path 126, which are arranged in the stated order from the upstream side. The inside diameter of the smaller-diameter flow path 126 is smaller than the inside diameter of the larger-diameter flow path 124. The extremity of the smaller-diameter flow path 126 coincides with the second end 116B of the second flow path 116 and is the site at which the connection point 123 is provided.

This feature enables the first piezoelectric pump 10 and the second piezoelectric pump 12 of the atomizer 102 to go into action at the same time, which in turn produces flows (indicated by the arrows A1, A2, A3, B1, B2, B3, C, and D) just as in the case of the atomizer 2 according to Embodiment 1 as illustrated in FIG. 10.

As illustrated in FIG. 11, a flow of gas through the first flow path 114 (indicated by an arrow E1) and a flow of liquid through the second flow path 116 (indicated by an arrow F) enter the connection point 123, at which the gas mixes with the liquid. The flow rates and velocities of the gas and the liquid fed to the connection point 123 are preset to predetermined values at which conditions needed for atomization are satisfied. A mixture of gas and liquid is formed at the connection point 123 and is then atomized at the second larger-diameter flow path 122 as indicated by an arrow E2. The atomized liquid reaches the second end 114B of the first flow path 114 and is then jetted out through the outlet 8 as indicated by the arrow A3.

As in the atomizer according to the embodiment described above, the Venturi effect produced at the connection point 123 may be used for atomization in the atomizer 102 according to Embodiment 2. More specifically, the first flow path 114 has the first end 114A and the second end 114B. The first end 114A is connected to the outlet 10A of the first piezoelectric pump 10. The connection point 123 is provided between the first end 114A and the second end 114B. The second flow path 116 has the first end 116A and the second end 116B. The first end 116A is connected to the tank 21, and the second end 116B is connected to the connection point 123.

In operating the first piezoelectric pump 10 serving as a driving source for ejecting gas, output conditions, such as driving frequencies may be preset such that the settings including the flow rate of the gas are adjusted accordingly. Thus, the degree of design difficulty associated with optimizing the liquid-gas ratio for atomizing liquid and with optimizing the velocity of flow of gas for the purpose of producing the Venturi effect is lower for the atomizer including the piezoelectric pump than for atomizers including other types of pumps, and atomization is thus more easily controllable.

The first flow path 114 and the second flow path 116 in the atomizer 102 according to Embodiment 2, respectively, include the smaller-diameter flow paths 120 and 126, in which the pressure and velocity of the gas transferred through the first flow path 114 and the pressure and velocity of the liquid transferred through the second flow path 116 are momentarily increased to help produce the Venturi effect.

Comparison of Piezoelectric Pump and Motor Pump

The atomizer 2 according to Embodiment 1 and the atomizer 102 according to Embodiment 2 use the piezoelectric pumps 10 and 12 as a power source and thus have superiority in the following respects to conventional atomizers that use motor pumps (diaphragm pumps) as a power source.

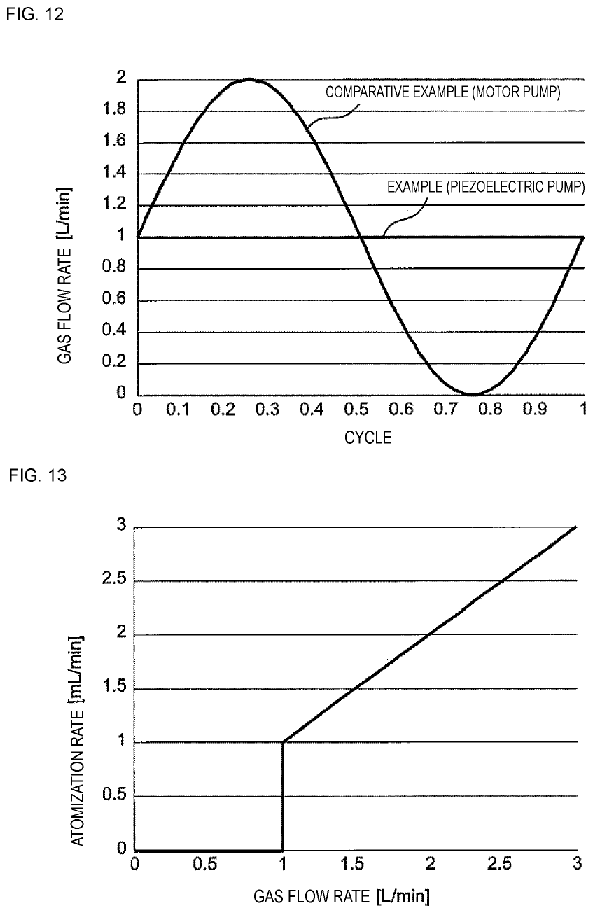

Such an atomizer including a motor pump would reduce liquid into fine particles of varying sizes due to strong pulsations caused by low-frequency oscillations. One potential drawback associated with the pulsation cycle is the occurrence of blanks in which atomization is stopped due to an insufficient flow rate. The occurrence of blanks results in low atomization efficiency. Contrastingly, the oscillation frequency in such an atomizer including piezoelectric pumps is so high that pulsations are substantially negligible. The atomizer is thus capable of reducing liquid into fine particles of uniform size and achieving increased atomization efficiency. This will be further elaborated below with reference to FIGS. 12 to 18.

FIG. 12 is a graph illustrating results obtained in relation to pulsations generated in an atomizer in Example and pulsations generated in an atomizer in Comparative Example for the case in which the atomizers are operated under predetermined conditions. The atomizer in Example includes a piezoelectric pump, and the atomizer in Comparative Example includes a motor pump. The horizontal axis of the graph in FIG. 12 represents the pulsation cycle (no unit required), and the vertical axis of the graph represents the gas flow rate (in units of L/min). The gas flow rate herein refers to the rate of flow of gas transferred through each atomizer by the action of the corresponding pump.

As can be seen from FIG. 12, the gas flow rate in the atomizer in Comparative Example varies widely in one pulsation cycle. More specifically, the gas flow rate fluctuates in a sinusoidal cyclic pattern, with the minimum flow rate of about 0 L/min and the maximum flow rate of about 2 L/min. The atomizer in Example exhibits no substantial fluctuation in the gas flow rate in each cycle and maintains a flow rate of about 1 L/min, which is the average flow rate of the atomizer.

FIG. 13 is a graph illustrating the relationship between the gas flow rate and the atomization rate in the present embodiment. The horizontal axis of the graph represents the gas flow rate (in units of L/min), and the vertical axis of the graph represents the atomization rate (in units of mL/min). The atomization rate herein refers to the rate of flow of a fine spray of a mixture of gas and liquid. As can be seen from FIG. 13, the atomization rate for the case that the gas flow rate is less than about 1 L/min remains zero, whereas the atomization rate for the case that the gas flow rate is equal to or more than about 1 L/min equates to the total gas flow rate. This means that a gas flow rate of about 1 L/min or more is a prerequisite for achieving atomization in the present embodiment.

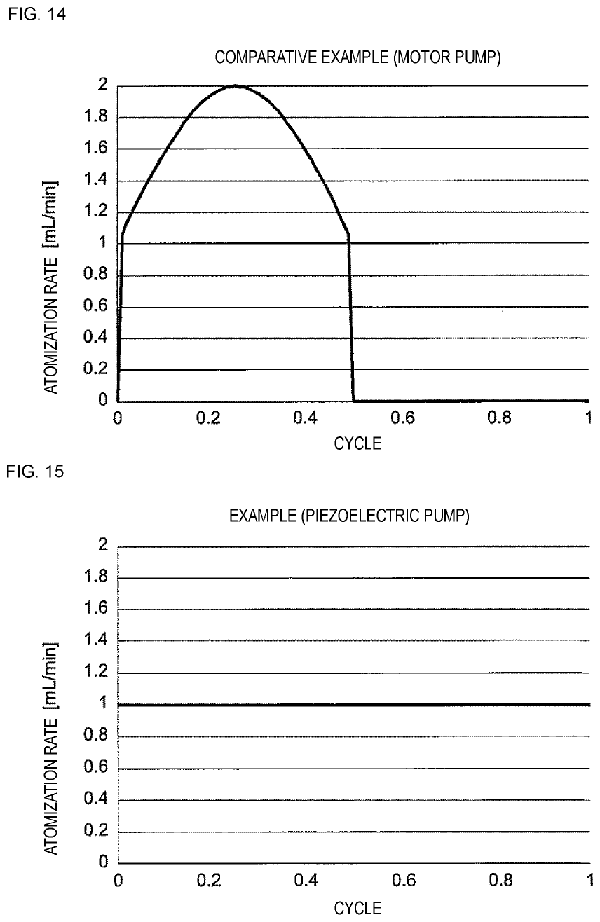

With regard to the atomizer in Comparative Example, it can be seen from FIG. 12 that the gas flow rate in the zero to 0.5 cycle range stays at about 1 L/min or above and the gas flow rate in the 0.5 to one cycle range stays below about 1 L/min. Applying the relationship illustrated FIG. 13 to the atomizer in Comparative Example leads to the conclusion that atomization in the zero to 0.5 cycle range is possible but not in the 0.5 to one cycle range. This is demonstrated in FIG. 14. The horizontal axis of the graph in FIG. 14 represents the pulsation cycle (no unit required), and the vertical axis of the graph represents the atomization rate (in units of mL/min). It can be seen from FIG. 14 that the atomization rate in the 0.5 to one cycle range remains at zero although the atomization rate in the zero to 0.5 cycle range is commensurate with the gas flow rate.

With regard to the atomizer in Example, it can be seen from FIG. 12 that the gas flow rate in the zero to one cycle range is maintained at 1 L/min. It is thus ensured that the flow rate is kept high enough to atomize liquid. The atomizer can continuously atomize liquid accordingly. This is demonstrated in FIG. 15. The horizontal axis of the graph in FIG. 15 represents the pulsation cycle (no unit required), and the vertical axis of the graph represents the atomization rate (in units of mL/min). It can be seen from FIG. 15 that an atomization rate of about 1 mL is maintained in the zero to one cycle range.

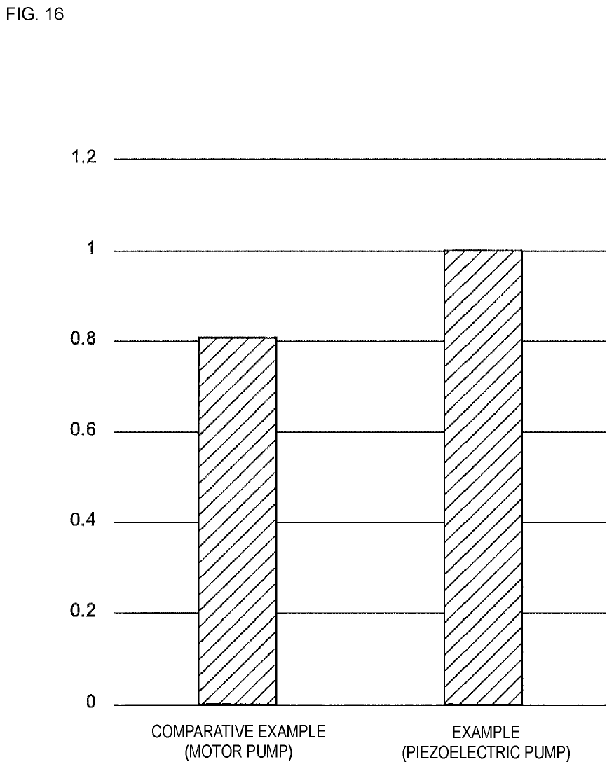

Referring to the graphs in FIGS. 14 and 15, the area of the region defined by the line denoting the atomization rate represents the total amount of flow atomized in one pulsation cycle. The total amounts of flow determined by calculation are as shown in FIG. 16. The vertical axis of the graph in FIG. 16 represents the ratio of the total amount of flow atomized in one pulsation cycle. It can be seen from FIG. 16 that the total amount of flow atomized by the atomizer in Comparative Example and the total amount of flow atomized by the atomizer in Example are approximately in a ratio of 0.8:1.

As is clear from the comparison in FIG. 16, the total amount of flow that can be atomized by the atomizer in Example is higher than the total amount of flow that can be atomized by the atomizer in Comparative Example; that is, the atomization rate of the atomizer in Example is higher than the atomization rate of the atomizer in Comparative Example.

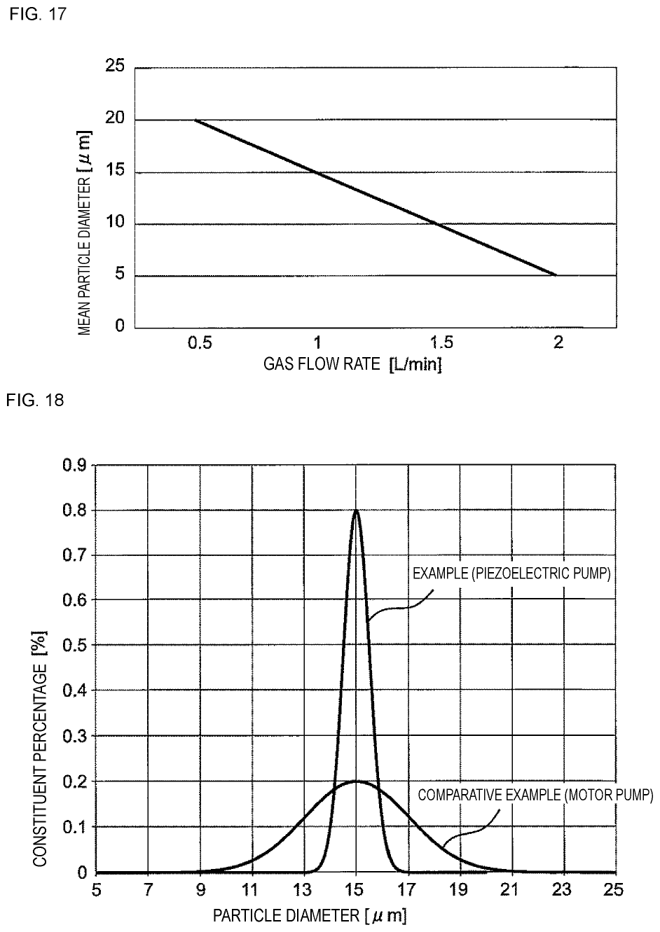

FIG. 17 illustrates the relationship between the flow rate and the particle diameter. The horizontal axis of the graph in FIG. 17 represents the gas flow rate (in units of L/min), and the vertical axis of the graph represents the mean diameter (in units of μm) of particles of atomized liquid in relation to varying flow rates plotted on the horizontal axis.

As can be seen from FIG. 17, the mean diameter of particles of atomized liquid decreases with increasing gas flow rate.

Applying the relationship between the flow rate and the particle diameter (see FIG. 17) to the variations in the gas flow rate in one pulsation cycle (see FIG. 12) yields FIG. 18. The horizontal axis of the graph in FIG. 18 represents the diameter of particles of atomized liquid (in units of μm), and the vertical axis of the graph represents the constituent percentage (%) of the particles in relation to varying particle diameters.

As can be seen from FIG. 18, the gas flow rate in the atomizer in Comparative Example varies widely in one pulsation cycle such that a wide range of variation in particle diameter is exhibited. The gas flow rate in the atomizer in Example is substantially constant in one pulsation cycle such that the particle diameters are small in variation.

As is clear from the comparison in FIG. 18, the range of variations in the diameter of particles of liquid atomized by the atomizer in Example is narrower than the range of variations in the diameter of particles of liquid atomized by the atomizer in Comparative Example; that is, the atomizer in Example has superiority over the atomizer in Comparative Example in reducing liquid into fine particles of uniform size.

As already mentioned above, the results in FIGS. 12 to 18 demonstrate that the atomizer 2 according to Embodiment 1 and the atomizer 102 according to Embodiment 2, each of which include the piezoelectric pumps 10 and 12 as a driving source, offer an improvement over the conventional atomizer including motor pumps as a driving source, or more specifically, are more capable of reducing liquid into fine particles of uniform size and achieving increased atomization efficiency.

While the present disclosure has been thoroughly described so far by way of embodiments with reference to the accompanying drawings, variations and modifications will be apparent to those skilled in the art. It should be understood that the variations and modifications made without necessarily departing from the scope hereinafter claimed are also embraced by the present disclosure. Constituent components described in the embodiments above may be used in varying combinations or may be placed in varying orders without necessarily departing from the scope of the present disclosure and from ideas disclosed herein.

### INDUSTRIAL APPLICABILITY

Potential uses of the present disclosure include medical atomizers and beauty care atomizers.

### REFERENCE SIGNS LIST

2 atomizer

4 case

4A first case portion

4B second case portion

6 switch

8 outlet

10 first piezoelectric pump

10A outlet

12 second piezoelectric pump

12A outlet

14 first flow path

14A first end of the first flow path

14B second end of the first flow path

16 second flow path

16A first end of the second flow path

16B second end of the second flow path

18 third flow path

18A first end of the third flow path

18B second end of the third flow path

20 bypass flow path

21 tank

22 control board

24 connection point

25 tip portion

26 connection point

28 connection point

30 flow-path resistive member

32 branch flow path

34 backflow prevention mechanism

40 backflow prevention valve

50 mesh member

60 constricted section

114 first flow path

114A first end

114B second end

116 second flow path

116A first end

116B second end

118 first larger-diameter flow path

120 smaller-diameter flow path

122 second larger-diameter flow path

123 connection point

124 larger-diameter flow path

126 smaller-diameter flow path

1. An atomizer comprising:
a first piezoelectric pump that ejects gas through an outlet;
a first flow path having a first end and a second end, the first end of the first flow path being connected to the outlet of the first piezoelectric pump;
a connection point between the first and second ends of the first flow path;
a reservoir for storing liquid; and
a second flow path having a first end and a second end, the first end of the second flow path being connected to the reservoir, the second end of the second flow path being connected to the connection point.

2. The atomizer according to claim 1, further comprising a branch flow path having a first end and a second end, the first end of the branch flow path being connected between the first end of the first flow path and the connection point, the second end of the branch flow path being connected to the reservoir.

3. The atomizer according to claim 2, wherein the branch flow path comprises a backflow prevention mechanism that eliminates or reduces occurrence of backflow of liquid.

4. The atomizer according to claim 1, further comprising:
a second piezoelectric pump that ejects gas through an outlet; and
a third flow path having a first end and a second end, the first end of the third flow path being connected to the outlet of the second piezoelectric pump, the second end of the third flow path being connected to the reservoir.

5. The atomizer according to claim 4, further comprising a bypass flow path through which a spot on the first flow path between the first end of the first flow path and the connection point is connected to the third flow path.

6. The atomizer according to claim 5, wherein the third flow path comprises a flow-path resistive member that is closer than a junction of the third flow path and the bypass flow path to the second end of the third flow path.

7. The atomizer according to claim 4, wherein the third flow path comprises a backflow prevention mechanism that eliminates or reduces occurrence of backflow of liquid.

8. The atomizer according to claim 1, wherein the first flow path extends in a straight line from the first end to the second end.

9. The atomizer according to claim 1, further comprising a case comprising at least the first piezoelectric pump, the first flow path, the second flow path, and the reservoir.

10. The atomizer according to claim 9, wherein the reservoir is a tank housed in the case.

11. The atomizer according to claim 1, wherein the second flow path is connected to the first flow path in a manner so as to cross the first flow path, with a tip portion of the second flow path being bent in the first flow path and extending toward the second end of the first flow path in such a manner that the first flow path and the tip portion of the second flow path in the first flow path are concentric.

12. The atomizer according to claim 5, wherein the third flow path comprises a backflow prevention mechanism that eliminates or reduces occurrence of backflow of liquid.

13. The atomizer according to claim 6, wherein the third flow path comprises a backflow prevention mechanism that eliminates or reduces occurrence of backflow of liquid.

14. The atomizer according to claim 2, wherein the first flow path extends in a straight line from the first end to the second end.

15. The atomizer according to claim 3, wherein the first flow path extends in a straight line from the first end to the second end.

16. The atomizer according to claim 4, wherein the first flow path extends in a straight line from the first end to the second end.

17. The atomizer according to claim 5, wherein the first flow path extends in a straight line from the first end to the second end.

18. The atomizer according to claim 6, wherein the first flow path extends in a straight line from the first end to the second end.

19. The atomizer according to claim 7, wherein the first flow path extends in a straight line from the first end to the second end.

20. The atomizer according to claim 2, further comprising a case comprising at least the first piezoelectric pump, the first flow path, the second flow path, and the reservoir.
